(19) United States
(12) Patent Application Publication
(10) Pub. No.: US 2024/0376326 A1
(43) Pub. Date: Nov. 14, 2024

(54) Fire Retardant

(71) Applicant: Louis Christiaan Koekemoer, Muldersdrift (ZA)

(72) Inventor: Louis Christiaan Koekemoer, Muldersdrift (ZA)

(21) Appl. No.: 18/692,243

(22) PCT Filed: Sep. 17, 2022
(86) PCT No.: PCT/IB2022/058795

§ 371 Date: Mar. 14, 2024

(30) Foreign Application Priority Data
Sep. 17, 2021 (ZA) 2021/06820

(51) Int. Cl. C09D 5/18; A62D 1/00; C09D 7/61; C09D 133/02

(52) U.S. Cl. CPC C09D 5/185; A62D 1/0064; C09D 7/61; C09D 133/02

(57) ABSTRACT

A fire retardant composition, gel, and a method of delivering a fire retardant, the fire retardant composition including: a polyacrylate polymer, a mixture of minerals of montmorillonite, quartz, and mica; and sodium oxide, and the method of delivering the fire retardant including providing the fire retardant powder composition; mixing water with the fire retardant powder composition in specific ratios; and delivering the fire retardant to a target zone.

### TECHNICAL FIELD

This invention relates to a fire retardant composition and a fired retardant gel. The invention also relates to a method of delivering a fire retardant and a method of delivering a fire retardant gel.

The invention is expected to be particularly advantageously applicable to the preventing and extinguishing of: lithium battery fires (for example in hybrid cars, electric cars, mobile phones and computers); magnesium fires; coal fires (for example in cooling down of burning stock piles and extinguishing of burning coal); and bush, runaway and household fires (such as the fighting of plantation fires and burning of firebreaks, fighting of Class A fires and wildfires, protecting of property against fire risk, and use in irrigation systems). Accordingly, such applications should particularly, but not exclusively, be borne in mind when considering this specification.

In this specification, the term “sodium oxide” should be broadly interpreted to describe components of various materials that contain oxides and other elements.

### BACKGROUND ART

Fire retardants are well-known for their use in preventing and extinguishing fires. Apart from their toxicity, the challenge lies in the transporting of and dispensing of volumes of fire retardant at a site. The present invention aims to overcome this challenge by providing a method of preventing and extinguishing fires with a portable and non-toxic fire retardant that can be rapidly transported to and easily delivered at a site.

### SUMMARY OF THE INVENTION

According to a first aspect of the invention there is provided a fire retardant powder composition which includes:
a polymer;
a mixture of minerals; and
sodium oxide.

The polymer may include a polyacrylate.

The mixture of minerals may include montmorillonite, quartz, and mica.

The fire retardant powder composition may constitute between 50% and 90% by weight of polyacrylate and between 10% and 50% of the mixture of minerals and sodium oxide by weight.

The fire retardant powder composition may constitute about 72% by weight of polyacrylate and about 28% by weight of the mixture of montmorillonite, quartz, mica, and sodium oxide.

The polyacrylate may include potassium acrylate.

The mica may include silicon dioxide.

The fire retardant powder composition may constitute between 2 and 20% by weight of silicon dioxide.

The fire retardant powder composition may constitute about 9.8% by weight of silicon dioxide.

The montmorillonite may include any one or more of magnesium oxide, calcium oxide, and potassium oxide.

The fire retardant powder composition may constitute between 0.2% and 5% by weight of magnesium oxide.

The fire retardant powder composition may constitute about 1.7% by weight of magnesium oxide.

The fire retardant powder composition may constitute between 1% and 5% by weight of calcium oxide.

The fire retardant powder composition may constitute about 2.9% by weight of calcium oxide.

The fire retardant powder composition may constitute between 0.1% and 1.5% by weight of potassium oxide.

The fire retardant powder composition may constitute about 0.5% by weight of potassium oxide.

The sodium oxide may include any one or more of aluminium oxide, iron oxide, titanium dioxide and lithium oxide.

The fire retardant powder composition may constitute between 1% and 5% by weight of aluminium oxide.

The fire retardant powder composition may constitute about 3.7% by weight of aluminium oxide.

The fire retardant powder composition may constitute between 1% and 3% by weight of iron oxide.

The fire retardant powder composition may constitute about 2% by weight of iron oxide.

The fire retardant powder composition may constitute between 0.01% and 1% by weight of titanium dioxide.

The fire retardant powder composition may constitute about 0.1% by weight of titanium dioxide.

The fire retardant powder composition may constitute between 2% and 10% by weight of lithium oxide.

The fire retardant powder composition may constitute about 6.8% by weight of lithium oxide.

It should be appreciated that the fire retardant powder composition may be produced and distributed in powder form to reduce transport and storage requirements. Accordingly, the powder may be rapidly supplied to target zones in substantial quantities.

According to another aspect of the invention there is provided a fire retardant gel which includes:
a fire retardant powder composition as hereinbefore described; and
water, wherein the composition is expanded by between 10 and 350 times its mass by the water.

The water may include de-ionized water.

The composition may be expanded by about 14 times its mass by the water.

The composition may be expanded by about 300 times its mass by the water.

The fire retardant gel may have a PH of about 0.

The fire retardant gel may be non-corrosive.

The fire retardant gel may be non-toxic.

It should be appreciated that the gel in use for bush fires, runaway fires, and household fires: the fire retardant gel is successful in the fighting of plantation fires, were a product that seeps into the undergrowth is required as well as protecting and stopping the fire burning the trees and forest.

It should be appreciated that the gel in use and when mixed in a specific method and ratio is used in the fighting of lithium battery fires. The product brings the temperature down from 400° C. to 35° C. degrees in less than a minute.

It should be appreciated that the gel in use and when mixed for the specific use of cooling down of burning coal stockpiles and extinguishing fires of coal that is aflame, the gel brings down the temperature of hot holes found in the coal mining industry from over 100° C. to 40° C. for several hours allowing enough time for the hot holes to be blasted.

Although the gel is water-based, it is highly effective in preventing magnesium from burning and catching alight. Once treated with the gel product, the stockpile will not catch alight from another source, withstanding up to 3000° C.

The combination of the ingredients and the way that the ingredients are blended result in a product that kills lithium and coal fires (for example in the mining Industry).

It should be appreciated that the composition and gel as described is the only product that successfully kills lithium fires (such as those found in hybrid, electric cars, cell phones and computers).

According to yet another aspect of the invention there is provided a method of delivering a fire retardant, which includes
providing a fire retardant powder composition as hereinbefore described;

mixing water with the fire retardant powder composition; and
delivering the fire retardant to a target zone.

The water may be mixed with the powder in a ratio of 600 litres to 1000 litres of water by volume and 1 kg to 2 kg fire retardant powder composition by weight for bulk firefighting.

The water may be mixed with the powder in a ratio of 17 litres to 23 litres of water by volume and 150 g to 200 g fire retardant powder composition by weight for fire extinguishers.

The water may be mixed with the powder in a ratio of 17 litres to 23 litres of water by volume and 350 g to 450 g fire retardant powder composition by weight for fighting lithium fires.

The fire retardant gel may be delivered to the target zone in a film thickness of between 10 m² and 15 m² per litre.

The fire retardant powder composition may be provided in 1.25 kg packages.

The 1.25 kg packages may be mixed with 600/of water for fire breaks and 1000/of water for fighting fires.

In an ideal embodiment, the fire retardant powder composition may be mixed in a ration equivalent to about 1 kg of composition to 240/of water.

The packages may include any one or more of a sachet and a resealable bag.

It should be appreciated that the fire-retardant powder composition and fire retardant gel is biodegradable.

The invention is now described, by way of non-limiting example, with reference to the accompanying diagrammatic drawings.

### DRAWINGS

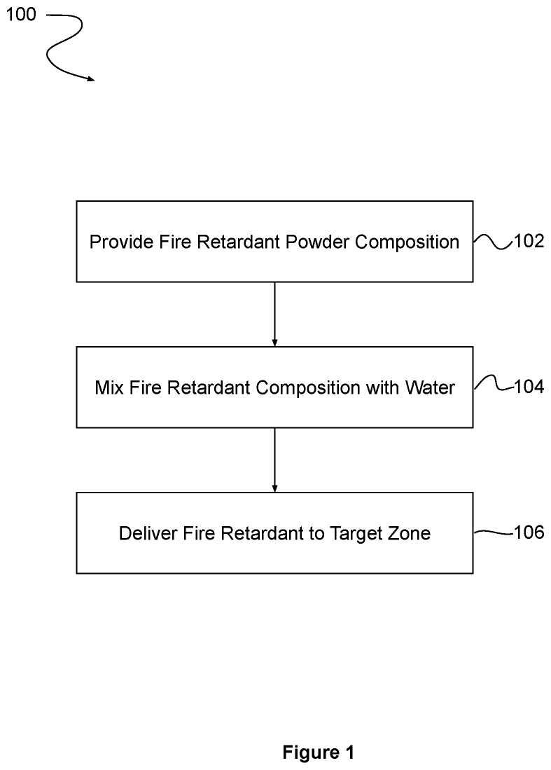

In the drawings, FIG. 1 illustrates, schematically, a method of delivering a fire retardant according to one aspect of the invention.

### DETAILED DESCRIPTION OF THE INVENTION

With reference to FIG. 1 of the drawings, reference numeral 10 denotes generally a method of delivering a fire retardant according to one embodiment of the invention.

At step (12), a fire retardant powder composition is provided.

In a preferred embodiment, the fire retardant powder composition constitutes 72.24% by weight of a potassium polyacrylate and 27.76% by weight of a mixture of sodium oxide and montmorillonite, quartz, and mica minerals.

In this embodiment, the mica includes silicon dioxide, and the composition constitutes 9.84% by weight of silicon dioxide. The montmorillonite includes magnesium oxide, calcium oxide, and potassium oxide. In particular, the composition constitutes 1.72% by weight of magnesium oxide, 2.9% by weight of calcium oxide, and 0.47% by weight of potassium oxide.

Further in this preferred embodiment, the sodium oxide includes aluminium oxide, iron oxide, titanium dioxide, and lithium oxide. In particular, the composition constitutes 3.65% by weight of aluminium oxide, 2.05% of iron oxide, 0.18% by weight of titanium dioxide, and 6.77% by weight of lithium oxide.

Next at step (14), the fire retardant powder is mixed with water.

In one preferred embodiment, the water is mixed with the powder in a ratio of 600 litres to 1000 litres of water by volume and 1.25 kg of fire retardant powder composition by weight for bulk firefighting.

In another preferred embodiment, the water is mixed with the powder in a ratio of 20 litres of water by volume and 175 g of fire retardant powder composition by weight for fire extinguishers.

In another preferred embodiment, the water is mixed with the powder in a ratio of 20 litres of water by volume and 400 g of fire retardant powder composition by weight for fighting lithium fires.

At step (16), the fire retardant is delivered to a target zone.

Advantageously, in use, the fire retardant gel as hereinbefore described coats a fire, thereby protecting items from the fire, removes oxygen, absorbs heat, and separates a fuel load from the fire.

Advantageously, in use, a gel as hereinbefore described may be used in the hybrid and electric car market to fight fires, and allow for the removal of cars from the scene of the accident or fire. Because of the zero PH level the gel is utilized on aircrafts to extinguish cell phones and computers that catch alight.

It should be appreciated that existing retardants do not combine superabsorbent polymers with the same or similar materials and are only 20 times in weight in water whereas the gel of the present invention combined with several materials makes it 300 times its weight in water, resulting in far stronger and higher adhesive properties. Furthermore, use of the gel of the present invention results in a far higher flash point level of the product.

1. A fire retardant powder composition comprising:
a potassium-based polymer;
a mixture of minerals;
and sodium oxide.

2. The fire retardant powder composition of claim 1 wherein the potassium-based polymer is a polyacrylate and the mixture of minerals comprises montmorillonite, quartz, and mica.

3. The fire retardant powder composition of claim 1 which comprises between 50% and 90% by weight of polyacrylate and between 10% and 50% of the mixture of minerals and sodium oxide by weight as an extinguishing agent for a lithium battery in thermal runaway.

4. The fire retardant powder composition of claim 1 which comprises about 50% by weight of polyacrylate and about 50% of the mixture of minerals and sodium oxide by weight.

5. The fire retardant powder composition of claim 2 which comprises about 72% by weight of polyacrylate and about 28% by weight of the mixture of montmorillonite, quartz, mica, and sodium oxide.

6. (canceled).

7. The fire retardant powder composition of claim 2 wherein the mica comprises silicon dioxide of between 2% and 20% by weight of silicon dioxide and about 9.8% by weight of silicon dioxide.

8. (canceled).

9. (canceled).

10. The fire retardant powder composition of claim 2 wherein the montmorillonite comprises magnesium oxide of between 0.2% and 5% by weight of magnesium oxide and about 1.7% by weight of magnesium oxide.

11. (canceled).

12. (canceled).

13. The fire retardant powder composition of claim 2 wherein the montmorillonite comprises calcium oxide of between 1% and 5% by weight of calcium oxide and about 2.9% by weigh of calcium oxide.

14. (canceled).

15. The fire retardant powder composition of claim 2 wherein the montmorillonite comprises potassium oxide of between 0.1% and 1.5% by weight of potassium oxide and about 0.5% by weight of potassium oxide.

16. (canceled).

17. The fire retardant powder composition of claim 1 wherein the sodium oxide comprises of aluminum oxide; of between 1% and 3% by weight of aluminum oxide and about 3.7% by weight of aluminum oxide.

18. (canceled).

19. (canceled).

20. The fire retardant powder composition of claim 1 wherein the sodium oxide comprises of iron oxide of between 1% and 3% by weight of iron oxide and about 2% by weight of iron oxide.

21. (canceled).

22. The fire retardant powder composition of claim 1 wherein the sodium oxide comprises of titanium dioxide of between 0.01% and 1% by weight of titanium dioxide and about 0.1% by weight of titanium dioxide.

23. (canceled).

24. The fire retardant powder composition of claim 1 wherein the sodium oxide comprises of lithium oxide of between 2% and 10% by weight of lithium oxide and about 6.8% by weight of lithium oxide.

25. (canceled).

26. A fire retardant gel comprising:
a fire retardant powder composition of claims 1; and
de-ionized water, wherein the composition is expanded by between 10 and 350 times its mass by the de-ionized water and expanded by about 300 times its mass by the de-ionized water or expanded by about 14 times its mass by the de-ionized water.

27. (canceled).

28. (canceled).

29. (canceled).

30. The fire retardant gel of claim 26 that is non-toxic and non-corrosive and has a neutral pH.

31. (canceled).

32. The fire retardant gel of claim 26 that is operable to prevent magnesium from burning and catching alight and fight fires of temperatures of up to 3000° C.

33. (canceled).

34. (canceled).

35. A method of delivering a fire retardant comprising:
providing a fire retardant powder composition of claim 1;
mixing water with the fire retardant powder composition; and
delivering the fire retardant to a target zone.

36. The method of claim 35 wherein the water is mixed with the powder in a ratio of between 600 L and 1000 L of water by volume to between 1 kg and 2 kg fire retardant powder composition by weight for bulk firefighting, a ratio of between 17 L and 23 L of water to between 150 g and 200 g fire retardant powder composition for fire extinguishers, and a ratio of between 17 L and 23 L of water to between 350 g and 450 g of fire retardant powder composition for fighting lithium fires.

37. (canceled).

38. (canceled).

39. A method of delivering a fire retardant gel, the method comprising:
providing a fire retardant gel of claims 26.

40. (canceled).

41. (canceled).

42. (canceled).

43. (canceled).

44. (canceled).

45. (canceled).

46. (canceled).

47. A fire retardant gel as claimed in claim 26 that is operable to encapsulate a lithium battery fire and prevent the fire from re-igniting in use.
